(19) United States
(12) Patent Application Publication
(10) Pub. No.: US 2026/0017371 A1
(43) Pub. Date: Jan. 15, 2026

(54) UNLEARNING APPARATUS BASED ON LAYER-WISE ATTACK AND METHOD OF OPERATING SAME

(71) Applicant: RESEARCH & BUSINESS FOUNDATION SUNGKYUNKWAN UNIVERSITY, Suwon-si (KR)

(72) Inventors: Hyunjune KIM, Suwon-si (KR); Sangyong LEE, Suwon-si (KR); Simon Sungil WOO, Suwon-si (KR)

(21) Appl. No.: 19/232,143

(22) Filed: Jun. 9, 2025

(30) Foreign Application Priority Data
Jul. 10, 2024 (KR) 10-2024-0091360

(51) Int. Cl. G06F 21/56; G06N 20/00

(52) U.S. Cl. CPC G06F 21/566; G06N 20/00; G06F 2221/033

(57) ABSTRACT

There is provided a method for unlearning to be performed by an unlearning apparatus, the method comprising: receiving to-be-forgotten target data as input; extracting a feature vector from the to-be-forgotten target data using a first layer that is a pre-attack layer of a pre-trained model; setting a second layer, which is a target attack layer of the pre-trained model, as a first model, and duplicating a second layer to generate a duplicated second layer to be set as a second model; generating a noisy feature vector by adding noise to the feature vector; fine-tuning one of the first model and the second model by applying a knowledge distillation technique to the first model and the second model using the feature vector and the noisy feature vector; and generating an unlearned model for the to-be-forgotten target data based on the first layer and the fine-tuned model.

### CROSS REFERENCE TO RELATED APPLICATION

The present application claims priority to Korean Patent Application No. 10-2024-0091360, filed on Jul. 10, 2024, the entire content of which is incorporated herein for all purposes by reference.

### BACKGROUND OF THE INVENTION

### Field of the Invention

The disclosure relates to a method, layer attack unlearning (LAU), for rapidly and effectively deleting data learned by a model, when a data owner requests deletion of specific data to an owner of a deep learning image classification model.

This work was supported by Institute of Information & communications Technology Planning & Evaluation (IITP) grant funded by the Korea government (Ministry of Science and ICT) (Project unique No.: 2710007095; Project No.: 2022-0-00688-002; R&D project: Development of core source technology for human-centered artificial intelligence; Research Project Title: Research and development of AI platforms that flexibly reflect and comply with changes in privacy-related policies; and Project period: 2024.01.01.˜2024.12.31.), Institute of Information & communications Technology Planning & Evaluation (IITP) grant funded by the Korea government (Ministry of Science and ICT) (Project unique No.: 2710008048; Project No.: 00230337; R&D project: Development of digital dysfunction response technology; Research Project Title: Development of a platform to enhance deepfake detection, suppress creation, and prevent distribution to counter maliciously altered content; and Project period: 2024.01.01.˜2024.12.31.), National Research Foundation of Korea (NRF) grant funded by the Korea government (Ministry of Science and ICT) (Project unique No.: 2710005684; Project No.: 00356293; R&D project: Individual Basic Research (Ministry of Science and ICT; Research Project Title: Research on advanced harmful multimedia content detection and deletion learning techniques using AI techniques; and Project period: 2024.01.01.˜2025.03.31.), and Institute of Information & communications Technology Planning & Evaluation (IITP) grant funded by the Korea government (Ministry of Science and ICT) (Project unique No.: 2710008628; Project No.: II190421; R&D project: Information and Communication Broadcasting Innovation Talent Training (R&D); Research Project Title: Artificial Intelligence Graduate School Support (Sungkyunkwan University); and Project period: 2024.01.01.˜2024.12.31.).

### Description of the Related Art

In recent times, due to reasons such as privacy and bias, it has become frequent to remove specific data from deep learning models. However, training the model from scratch while excluding the corresponding data requires significant time and computational resources. Therefore, techniques that are capable of performing the above process more rapidly and effectively have been researched. However, most of the research either fails to properly perform the deletion or tends to negatively affect the information in other data. In addition, even when properly performed, it requires a large amount of required time and additional data. This method intensively removes characteristics of the deletion request data from the artificial neural network layer that has the greatest influence on classification in the model. In this case, for effective removal, the Partial-PGD technique is used, and to preserve the characteristics of the data that needs to be maintained, a knowledge distillation technique is employed.

The LAU method uses only the deletion request data among the entire training data and, in comparison with conventional techniques, showed the highest performance in 11 out of 12 combinations consisting of three datasets (CIFAR10, Fashion-MNIST, VGGFace2) and four deep learning models (VGG16, ResNet18, ResNet50, VIT), and the remaining one showed the second highest performance. In particular, in terms of execution time, it achieves up to approximately 1000 times faster performance compared to retraining. When a data owner requests deletion of their own information from a deep learning model, the owner of the deep learning model needs to delete that information from the model. However, retraining the model from scratch with the remaining data, excluding the corresponding data, is inefficient due to time and space costs. Accordingly, a machine unlearning method for efficiently solving such a problem is required.

However, in previous studies, there is a problem in that the entire information of the data that needs to be deleted is not completely removed, or the information of the data to be preserved is not fully maintained.

In addition, when all the data used for initial training needs to be stored, there is also a problem in that a cost is incurred to maintain the storage space for this purpose. In order to rapidly provide the service, it is also important to minimize the time cost.

### SUMMARY OF THE INVENTION

An object of the disclosure is to provide an unlearning technology through which an owner of a deep learning model efficiently deletes data from the model when a data deletion request occurs.

In addition, another object of the disclosure is to provide a technology that deletes the information of data to be removed as much as possible at minimum cost and time, while maintaining the information of data to be preserved as intact as possible.

In accordance with an aspect of a method for unlearning, the method comprising: receiving to-be-forgotten target data as input; extracting a feature vector from the to-be-forgotten target data using a first layer that is a pre-attack layer of a pre-trained model; setting a second layer, which is a target attack layer of the pre-trained model, as a first model, and duplicating a second layer to generate a duplicated second layer to be set as a second model; generating a noisy feature vector by adding noise to the feature vector; fine-tuning one of the first model and the second model by applying a knowledge distillation technique to the first model and the second model using the feature vector and the noisy feature vector; and generating an unlearned model for the to-be-forgotten target data based on the first layer and the fine-tuned model.

Wherein the first layer may include a convolution layer, and the second layer includes a fully-connected layer.

Wherein the duplicating the second layer may include duplicating the second layer for each epoch to set the duplicated second layer as the second model.

Wherein one of the first model and the second model may include a student model and the other may include a teacher model, and wherein the fine-tuning may include fine-tuning the student model.

Wherein the generating the noisy feature vector may include: a first step of calculating a gradient for a class of the feature vector itself after passing the feature vector through one of the first model and the second model; a second step of generating the noisy feature vector by multiplying a small value epsilon by a sign of the gradient and adding a result of a multiplication to the feature vector; and a third step of generating the noisy feature vector with noise finally added by repeating the first step and the second step.

Wherein the noisy feature vector with noise finally added may be generated according to Equation l^{t+1}=Π(l^{t}+(ϵ·sign(∇ₗ [symbol] (l, y, θ))).

Wherein the fine-tuning may include: generating a first logit by passing the feature vector through the first model; generating a second logit by passing the noisy feature vector through the second model; generating a smoothed second logit by smoothing the second logit using a softmax function; calculating a first loss value from the first logit and the smoothed second logit using a distillation loss function; calculating a second loss value from the first logit and the second logit using a cross-entropy loss function; calculating a KD loss value, which is a final loss value, from the first loss value and the second loss value using a knowledge distillation (KD) loss function; and fine-tuning the second model based on the KD loss value.

Wherein the generating the smoothed second logit by smoothing the second logit using the softmax function may contain replacing the second logit with the first logit when a prediction value of the first logit is different from an original prediction value.

Wherein the KD loss value may be expressed by Equation [symbol] =(1−α)· [symbol] +α·T²· [symbol] , where [symbol] denotes the KD loss function, [symbol] denotes the cross-entropy loss function, and [symbol] denotes the distillation loss function.

In accordance with another aspect of an apparatus for unlearning, the apparatus comprising: a memory storing at least one instruction; and a processor executing the at least one instruction stored in the memory, wherein the at least one instruction, when executed by the processor, causes the processor to: receive to-be-forgotten target data as input; extract a feature vector from the to-be-forgotten target data using a first layer that is a pre-attack layer of a pre-trained model; set a second layer, which is a target attack layer of the pre-trained model, as a first model, and duplicate a second layer to generate a duplicated second layer to be set as a second model; generate a noisy feature vector by adding noise to the feature vector; fine-tune one of the first model and the second model by applying a knowledge distillation technique to the first model and the second model using the feature vector and the noisy feature vector; and generate an unlearned model for the to-be-forgotten target data based on the first layer and the fine-tuned model.

In accordance with another aspect of a non-transitory computer-readable storage medium storing a computer program, wherein the computer program, when executed by at least one processor, causes the processor to perform a method including: receiving to-be-forgotten target data as input; extracting a feature vector from the to-be-forgotten target data using a first layer that is a pre-attack layer of a pre-trained model; setting a second layer, which is a target attack layer of the pre-trained model, as a first model, and duplicating a second layer to generate a duplicated second layer to be set as a second model; generating a noisy feature vector by adding noise to the feature vector; fine-tuning one of the first model and the second model by applying a knowledge distillation technique to the first model and the second model using the feature vector and the noisy feature vector; and generating an unlearned model for the to-be-forgotten target data based on the first layer and the fine-tuned model.

According to one aspect of the disclosure, information for which a deletion request has been made may be rapidly and effectively removed from an image classification deep learning model without retraining, using only a small number of images.

In addition, according to another aspect of the disclosure, compared to conventional technologies, image classification performance for the information to be preserved is excellently maintained, and at the same time, rapid unlearning becomes possible because only the target attack layer among the entire model is finely tuned.

### BRIEF DESCRIPTION OF THE DRAWINGS

FIG. 1 is a block diagram of an unlearning apparatus according to an embodiment of the disclosure.

FIG. 2 is a flowchart of an unlearning method according to an embodiment of the disclosure.

FIG. 3 is a flowchart illustrating a method of generating a noisy feature vector according to an embodiment of the disclosure.

FIG. 4 is a flowchart of a model fine-tuning method according to an embodiment of the disclosure.

FIGS. 5A and 5B are diagrams for illustrating a conventional PGD method and a PGD method according to the present invention.

FIG. 6 is a diagram for describing an unlearning process according to an embodiment of the disclosure.

FIG. 7 is a block diagram of an unlearning apparatus according to another embodiment of the disclosure.

### DETAILED DESCRIPTION OF THE INVENTION

The advantages and features of the present invention, and methods for achieving them, will be clearly understood from the embodiments described in detail below with reference to the accompanying drawings. However, the present invention is not limited to the embodiments disclosed herein, and may be embodied in various other forms. The embodiments are provided only to ensure the completeness of the disclosure of the present invention and to fully convey the scope of the invention to those skilled in the art. The scope of the present invention is defined only by the claims.

In the following description of the embodiments of the present invention, detailed descriptions of known functions and configurations that may unnecessarily obscure the essence of the invention will be omitted unless necessary. Furthermore, terms used in the present specification are defined in consideration of the functions of the embodiments of the invention, and may vary depending on the intention or practice of the user or operator. Therefore, the definitions should be interpreted based on the overall content of this specification.

The terms such as “unit,” “module,” or “device” used herein refer to components that perform at least one function or operation, and may be implemented as hardware, software, or a combination of both.

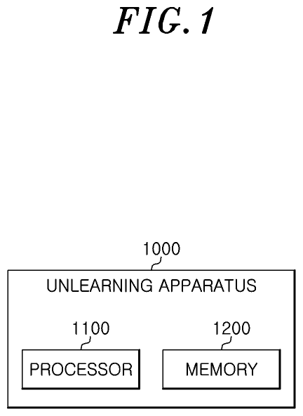

FIG. 1 is a block diagram of an unlearning apparatus according to an embodiment of the disclosure.

Referring to FIG. 1, an unlearning apparatus 1000 according to an embodiment of the present invention may include a processor 1100 and a memory 1200.

The processor 1100 may control overall operations of the unlearning apparatus 1000. Specifically, the processor 1100 may control unlearning operations of the unlearning apparatus 1000 by executing instructions stored in the memory 1200.

The memory 1200 may store instructions for performing unlearning and other instructions for controlling overall operations of the unlearning apparatus 1000.

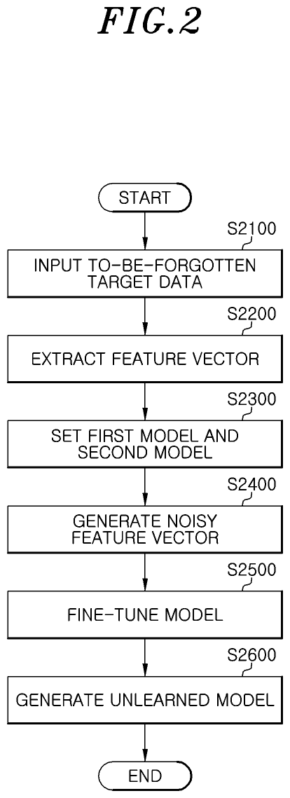

Hereinafter, specific operations of an unlearning apparatus 1000 will be described with reference to FIGS. 2 to 6.

FIG. 2 is a flowchart of an unlearning method according to an embodiment of the disclosure.

Hereinafter, the above-described method will be described by way of example as being performed by the unlearning apparatus 1000 illustrated in FIG. 1.

In step S2100, to-be-forgotten target data is input. Specifically, the unlearning apparatus 1000 may receive, as input, from a user, a data deletion request including the to-be-forgotten target data.

In step S2200, a feature vector is extracted. Specifically, the unlearning apparatus 1000 may determine a first layer, which is a pre-attack layer, and a second layer, which is a target attack layer from a pre-trained model targeted for unlearning. The unlearning apparatus 1000 may input the to-be-forgotten target data into the first layer and extract a feature vector as the output of the first layer.

In an embodiment, when the pre-trained model is a classification model for performing classification tasks, the first layer may be a convolution layer, and the second layer may be a fully-connected layer. This is merely one example, and it is apparent that the first layer and the second layer may vary depending on the type of pre-trained model.

In step S2300, a first model and a second model are set. Specifically, the unlearning apparatus 1000 may set the first model and the second model, which are to be used as a teacher model and a student model, respectively, in order to apply an unlearning technique based on knowledge distillation.

In an embodiment, either one of the first model and the second model may be set as the teacher model, or the other may be set as the student model.

In an embodiment, the unlearning apparatus 1000 may set a second layer as a first model, and duplicate a second layer to generate a duplicated second layer to be set as a second model.

In an embodiment, the unlearning apparatus 1000 may duplicate the second layer for each epoch to set the first model and the second model.

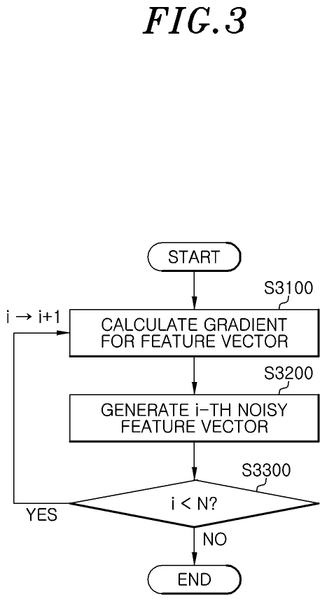

In step S2400, a noisy feature vector is generated. Specifically, the unlearning apparatus 1000 may generate a noisy feature vector by adding noise to the feature vector. Detailed description thereof will be provided below with reference to FIG. 3.

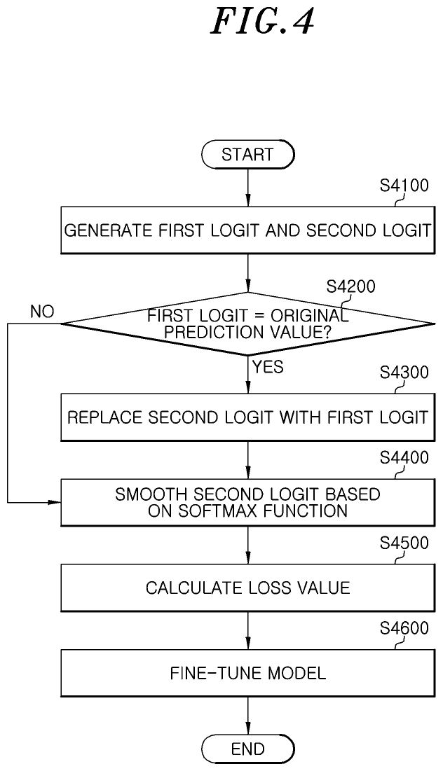

In step S2500, fine-tuning of the student model is performed. Specifically, the unlearning apparatus 1000 may fine-tune the student model, which is one of the first model and the second model, by calculating a loss value based on the feature vector and the noisy feature vector using knowledge distillation. Detailed description thereof will be provided below with reference to FIG. 4.

In step S2600, an unlearned model is generated. Specifically, the unlearning apparatus 1000 may generate the unlearned model from which the to-be-forgotten target data has been removed, based on the first layer and the fine-tuned model.

FIG. 3 is a flowchart illustrating a method of generating a noisy feature vector according to an embodiment of the disclosure.

Hereinafter, the above-described method will be described by way of example as being performed by the unlearning apparatus 1000 illustrated in FIG. 1.

In step S3100, the unlearning apparatus 1000 may pass the feature vector through the teacher model, and may calculate a gradient for the class of the feature vector itself based on the result passed through.

In step S3200, the unlearning apparatus 1000 may generate an i-th noisy feature vector by multiplying a small value by the sign of the gradient, and adding a result of the multiplication to the feature vector.

In step S3300, the unlearning apparatus 1000 may determine whether i is less than a preset N (an integer greater than or equal to 1), and when i is less than N, may perform step S3100 again.

In addition, the unlearning apparatus 1000 may determine an i-th noisy feature vector as a final noisy feature vector when i is equal to N.

Here, the final noisy feature vector may be expressed as Equation 1 below.

$${l}^{t + 1} = Π ( {l}^{t} + ( ϵ \cdot sign ( {∇}_{l} ℒ ( l , y , θ ) ) ) \qquad [ Equation 1 ]$$

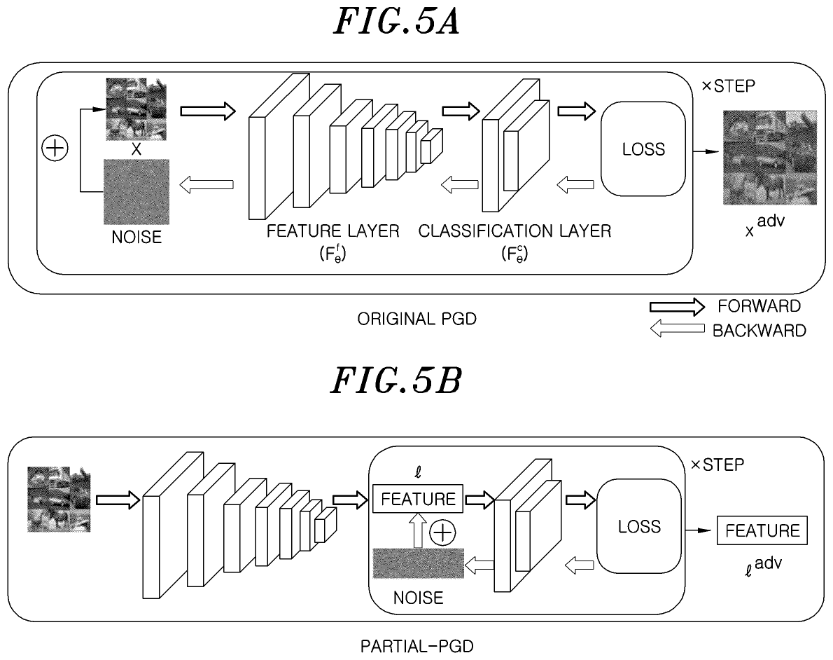

In the disclosure, a method of calculating the noisy feature vector employs a partial-PGD method, which performs unlearning on a specific target attack layer among all layers of the model, as illustrated in FIG. 5B, in contrast to performing unlearning on all layers of the model as in original PGD illustrated in FIG. 5A.

FIG. 4 is a flowchart of a model fine-tuning method according to an embodiment of the disclosure.

Hereinafter, the above-described method will be described by way of example as being performed by the unlearning apparatus 1000 illustrated in FIG. 1.

In step S4100, the unlearning apparatus 1000 may pass the feature vector through the first model to generate a first logit. The unlearning apparatus 1000 may pass the noisy feature vector through the second model to generate a second logit.

In step S4200, the unlearning apparatus 1000 may determine whether a prediction value of the first logit is different from an original prediction value. Here, the original prediction value may refer to the prediction value of the model targeted for unlearning before performing the unlearning.

In step S4300, when the prediction value of the first logit is different from the original prediction value, the unlearning apparatus 1000 may replace the second logit with the first logit. This is to avoid performing any further unlearning, because unlearning has been completed when the class of the first logit is different from the original class.

In step S4400, the unlearning apparatus 1000 may smooth the second logit using a softmax function.

In an embodiment, the softmax function may be expressed as Equation 2 below.

$$Z = \{ \begin{matrix}σ ( {T}_{θ} ( {l}_{f}^{adv} ) ) & if {y}_{{S}_{θ}} = {y}_{f} \\ σ ( {S}_{θ} ( {l}_{f} ) ) & otherwise ,\end{matrix} \qquad [ Equation 2 ]$$

In step S4500, the unlearning apparatus 1000 may calculate a knowledge distillation (KD) loss value based on the first logit and the smoothed second logit.

In an embodiment, the unlearning apparatus 1000 may calculate a first loss value from the first logit and the smoothed second logit using a distillation loss function. The unlearning apparatus 1000 may calculate a second loss value from the first logit and the second logit using a cross-entropy loss function. The unlearning apparatus 1000 may calculate the KD loss value, which is the final loss value, from the first loss value and the second loss value using the knowledge distillation (KD) loss function.

In an embodiment, the distillation loss function may be expressed as Equation 3 below.

$${ℒ}_{CE} = \{ \begin{matrix}CE ( {S}_{θ} ( {l}_{f} ) , {y}_{f}^{adv} ) & if {y}_{{S}_{θ}} = {y}_{f} \\ CE ( {S}_{θ} ( {l}_{f} ) , {y}_{{S}_{θ}} ) & otherwise ,\end{matrix} \qquad [ Equation 3 ]$$

In an embodiment, the cross-entropy loss function may be expressed as Equation 4 below.

$${ℒ}_{DI} = KL ( σ ( \frac{{S}_{θ} ( {l}_{f} )}{T} ) , σ ( \frac{Z}{T} ) ) \qquad [ Equation 4 ]$$

In an embodiment, the cross-entropy loss function may be expressed as Equation 5 below.

$$ℒ = ( 1 - α ) \cdot {ℒ}_{CE} + α \cdot {T}^{2} \cdot {ℒ}_{DI} \qquad [ Equation 5 ]$$

In step S4500, the unlearning apparatus 1000 may perform fine-tuning on the second model based on the KD loss value.

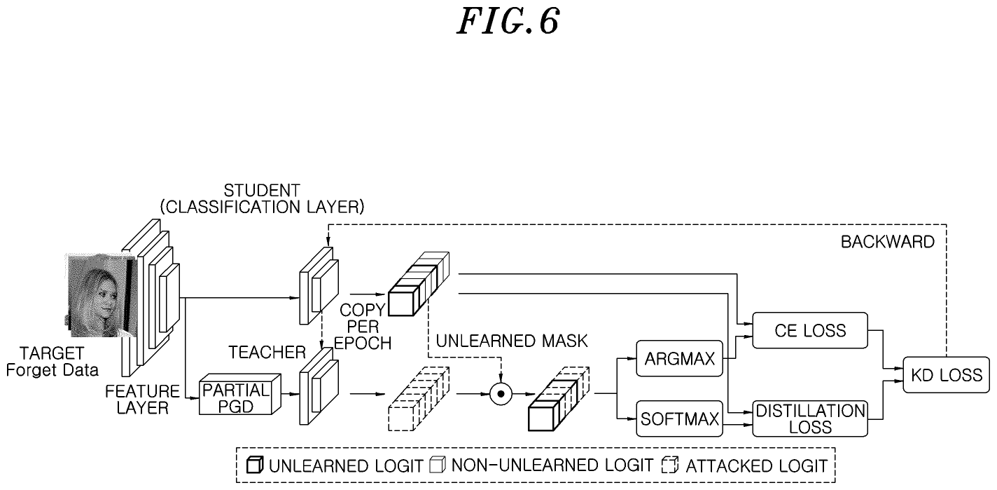

FIG. 6 is a diagram for describing an unlearning process according to an embodiment of the disclosure.

With reference to FIG. 6, an unlearning process according to an embodiment of the disclosure is illustrated. When to-be-forgotten target data is input, the unlearning apparatus 1000 may pass the to-be-forgotten target data through a feature extraction layer, which is a pre-attack layer, to extract a feature vector. The unlearning apparatus 1000 may duplicate a classification layer, which is a target attack layer, and may set the original as a teacher model and the duplicated classification layer as a student model. The unlearning apparatus 1000 may pass the feature vector through the teacher model to generate a noisy feature vector. The unlearning apparatus 1000 may pass the feature vector and the noisy feature vector through the teacher model and the student model, and may calculate a CE loss value using a cross-entropy loss function, and a distillation loss value using a distillation loss function, and finally, may calculate a KD loss value based on a knowledge distillation loss function.

The unlearning apparatus 1000 may fine-tune the classification layer, which is the target attack layer, using the KD loss value.

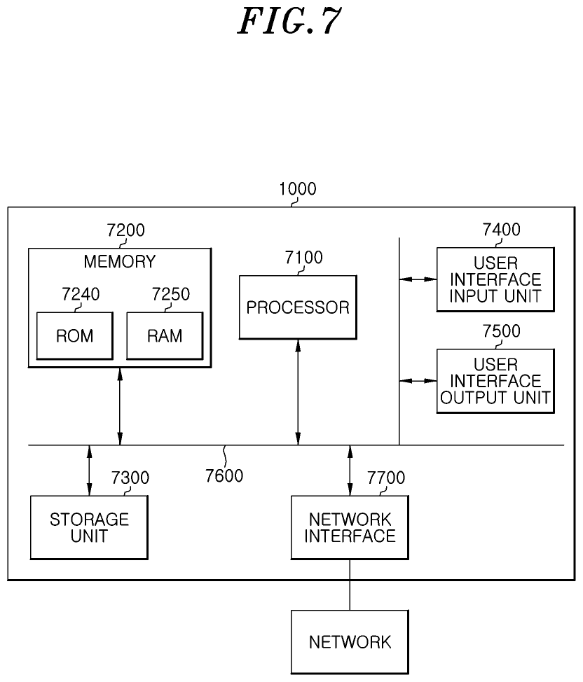

FIG. 7 is a block diagram of an unlearning apparatus according to another embodiment of the disclosure.

As illustrated in FIG. 7, the unlearning apparatus 1000 may include at least one of a processor 7100, a memory 7200, a storage unit 7300, a user interface input unit 7400, and a user interface output unit 7500, which may communicate with each other via a bus 7600. Additionally, the unlearning apparatus 1000 may further include a network interface 7700 for connecting to a network. The unlearning apparatus 1000 may be a CPU or a semiconductor apparatus that executes processing instructions stored in the memory 7200 and/or the storage unit 7300. The memory 7200 and the storage unit 7300 may include various types of volatile and non-volatile storage media. For example, the memory may include a ROM 7240 and a RAM 7250.

The apparatus described above may be implemented by hardware components, software components, or a combination of both hardware and software components. For example, the apparatuses and components described in the embodiments may be implemented using one or more general-purpose or special-purpose computers, such as a processor, controller, arithmetic logic unit (ALU), digital signal processor (DSP), microcomputer, field programmable array (FPA), programmable logic unit (PLU), microprocessor, or any other device capable of executing and responding to instructions.

The processing unit may execute an operating system (OS) and one or more software applications running on the OS. Additionally, the processing unit may access, store, manipulate, process, and generate data in response to the execution of software. For convenience of explanation, a single processing unit may be described; however, those skilled in the art will appreciate that the processing unit may include multiple processing elements and/or multiple types of processing elements. For example, the processing unit may include multiple processors or a combination of a processor and a controller. Other processing configurations, such as parallel processors, are also possible.

The software may include a computer program, code, instruction, or any combination thereof, and may configure or instruct the processing unit to operate as desired, either independently or collectively. The software and/or data may be embodied, permanently or temporarily, in any type of machine, component, physical or virtual device, computer-readable storage medium or device, or signal wave, in order to be interpreted by or supplied as instructions or data to the processing unit. The software may also be distributed across a networked computer system and be stored or executed in a distributed manner. The software and data may be stored in one or more non-transitory computer-readable storage medium.

The above description is merely exemplary description of the technical scope of the present disclosure, and it will be understood by those skilled in the art that various changes and modifications can be made without departing from original characteristics of the present disclosure. Therefore, the embodiments disclosed in the present disclosure are intended to explain, not to limit, the technical scope of the present disclosure, and the technical scope of the present disclosure is not limited by the embodiments. The protection scope of the present disclosure should be interpreted based on the following claims and it should be appreciated that all technical scopes included within a range equivalent thereto are included in the protection scope of the present disclosure.

What is claimed is:

1. A method for unlearning to be performed by an unlearning apparatus, the method comprising:
receiving to-be-forgotten target data as input;
extracting a feature vector from the to-be-forgotten target data using a first layer that is a pre-attack layer of a pre-trained model;
setting a second layer, which is a target attack layer of the pre-trained model, as a first model, and duplicating a second layer to generate a duplicated second layer to be set as a second model;
generating a noisy feature vector by adding noise to the feature vector;
fine-tuning one of the first model and the second model by applying a knowledge distillation technique to the first model and the second model using the feature vector and the noisy feature vector; and
generating an unlearned model for the to-be-forgotten target data based on the first layer and the fine-tuned model.

2. The unlearning method of claim 1, wherein the first layer includes a convolution layer, and the second layer includes a fully-connected layer.

3. The unlearning method of claim 1, wherein the duplicating the second layer includes:
duplicating the second layer for each epoch to set the duplicated second layer as the second model.

4. The unlearning method of claim 1, wherein one of the first model and the second model includes a student model, and the other includes a teacher model, and
wherein the fine-tuning includes:
fine-tuning the student model.

5. The unlearning method of claim 1, wherein the generating the noisy feature vector includes:
a first step of calculating a gradient for a class of the feature vector itself after passing the feature vector through one of the first model and the second model;
a second step of generating the noisy feature vector by multiplying a small value epsilon by a sign of the gradient and adding a result of a multiplication to the feature vector; and
a third step of generating the noisy feature vector with noise finally added by repeating the first step and the second step.

6. The unlearning method of claim 5, wherein the noisy feature vector with noise finally added is generated according Equation l^{t+1}=Π(l^{t}+(ϵ·sign(∇ₗ [symbol] (l, y, θ))).

7. The unlearning method of claim 1, wherein the fine-tuning includes:
generating a first logit by passing the feature vector through the first model;
generating a second logit by passing the noisy feature vector through the second model;
generating a smoothed second logit by smoothing the second logit using a softmax function;
calculating a first loss value from the first logit and the smoothed second logit using a distillation loss function;
calculating a second loss value from the first logit and the second logit using a cross-entropy loss function;
calculating a KD loss value, which is a final loss value, from the first loss value and the second loss value using a knowledge distillation (KD) loss function; and
fine-tuning the second model based on the KD loss value.

8. The unlearning method of claim 7, wherein the generating the smoothed second logit by smoothing the second logit using the softmax function contains:
replacing the second logit with the first logit when a prediction value of the first logit is different from an original prediction value.

9. The unlearning method of claim 7, wherein the KD loss value is expressed by Equation [symbol] =(1−α)· [symbol] +α·T²· [symbol] ,
where [symbol] denotes the KD loss function, [symbol] denotes the cross-entropy loss function, and [symbol] denotes the distillation loss function.

10. An apparatus for unlearning, the apparatus comprising:
a memory storing at least one instruction; and
a processor executing the at least one instruction stored in the memory,
wherein the at least one instruction, when executed by the processor, causes the processor to:
receive to-be-forgotten target data as input;
extract a feature vector from the to-be-forgotten target data using a first layer that is a pre-attack layer of a pre-trained model;
set a second layer, which is a target attack layer of the pre-trained model, as a first model, and duplicate a second layer to generate a duplicated second layer to be set as a second model;
generate a noisy feature vector by adding noise to the feature vector;
fine-tune one of the first model and the second model by applying a knowledge distillation technique to the first model and the second model using the feature vector and the noisy feature vector; and
generate an unlearned model for the to-be-forgotten target data based on the first layer and the fine-tuned model.

11. The apparatus of claim 10, wherein the first layer includes a convolution layer, and the second layer includes a fully-connected layer.

12. The apparatus of claim 10, wherein the at least one instruction, when executed by the processor, causes the processor further to:
duplicate the second layer for each epoch to set the duplicated second layer as the second model.

13. The apparatus of claim 10, wherein one of the first model and the second model includes a student model, and the other includes a teacher model, and
wherein the at least one instruction, when executed by the processor, causes the processor further to:
fine-tune the student model.

14. The apparatus of claim 10, wherein the at least one instruction, when executed by the processor, causes the processor to further
execute a first step of calculating a gradient for a class of the feature vector itself after passing the feature vector through one of the first model and the second model;
execute a second step of generating the noisy feature vector by multiplying a small value epsilon by a sign of the gradient and adding a result of a multiplication to the feature vector; and
execute a third step of generating the noisy feature vector with noise finally added by repeating the first step and the second step.

15. The apparatus of claim 14, wherein the noisy feature vector with noise finally added is generated according to Equation l^{t+1}=Π(l^{t}+(ϵ·sign(∇ₗ [symbol] (l, y, θ))).

16. The apparatus of claim 10, wherein the at least one instruction, when executed by the processor, causes the processor to further:
generate a first logit by passing the feature vector through the first model;
generate a second logit by passing the noisy feature vector through the second model;
generate a smoothed second logit by smoothing the second logit using a softmax function;
calculate a first loss value from the first logit and the smoothed second logit using a distillation loss function;
calculate a second loss value from the first logit and the second logit using a cross-entropy loss function;
calculate a KD loss value, which is a final loss value, from the first loss value and the second loss value using a knowledge distillation (KD) loss function; and
fine-tune the second model based on the KD loss value.

17. The apparatus of claim 16, wherein the at least one instruction, when executed by the processor, causes the processor to further:
replace the second logit with the first logit when a prediction value of the first logit is different from an original prediction value.

18. The apparatus of claim 16, wherein the KD loss value is expressed by Equation [symbol] =(1−α)· [symbol] +α·T²· [symbol] ,
where [symbol] denotes the KD loss function, [symbol] denotes the cross-entropy loss function, and [symbol] denotes the distillation loss function.

19. A non-transitory computer-readable storage medium storing a computer program, wherein the computer program, when executed by at least one processor, causes the processor to perform a method including:
receiving to-be-forgotten target data as input;
extracting a feature vector from the to-be-forgotten target data using a first layer that is a pre-attack layer of a pre-trained model;
setting a second layer, which is a target attack layer of the pre-trained model, as a first model, and duplicating a second layer to generate a duplicated second layer to be set as a second model;
generating a noisy feature vector by adding noise to the feature vector;
fine-tuning one of the first model and the second model by applying a knowledge distillation technique to the first model and the second model using the feature vector and the noisy feature vector; and
generating an unlearned model for the to-be-forgotten target data based on the first layer and the fine-tuned model.
